(19) United States
(12) Patent Application Publication
(10) Pub. No.: US 2017/0200451 A1
(43) Pub. Date: Jul. 13, 2017

(54) REPLAY ATTACK DETECTION IN AUTOMATIC SPEAKER VERIFICATION SYSTEMS

(71) Applicant: INTEL CORPORATION, Santa Clara, CA (US)

(72) Inventors: Tobias Bocklet, Munich (DE); Adam Marek, Gdansk (PL); Piotr Chlebek, Gdynia (PL)

(21) Appl. No.: 15/128,935

(22) PCT Filed: Jul. 4, 2014
(86) PCT No.: PCT/PL2014/050041

§ 371 Date: Sep. 23, 2016

(51) Int. Cl. G10L 17/08; G10L 17/02; G10L 17/16; G10L 25/24

(52) U.S. Cl. CPC G10L 17/08; G10L 25/24; G10L 17/02; G10L 17/16

(57) ABSTRACT

Techniques related to detecting replay attacks on automatic speaker verification systems are discussed. Such techniques may include receiving an utterance from a user or a device playing back the utterance, determining features associated with the utterance, and classifying the utterance in a replay utterance class or an original utterance class based on a statistical classification or a margin classification of the utterance using the features.

### BACKGROUND

Speaker recognition or automatic speaker verification may be used to identify a person who is speaking to a device based on, for example, characteristics of the speaker's voice. Such speaker identification may be used to accept or reject an identity claim based on the speaker's voice sample to restrict access to a device or an area of a building or the like. Such automatic speaker verification systems may be vulnerable to spoofing attacks such as replay attacks, voice transformation attacks, and the like. For example, replay attacks include an intruder secretly recording a person's voice and replaying the recording to the system during a verification attempt. Replay attacks are typically easy to perform and tend to have a high success rate. For example, evaluations have shown that as much as 60% of replayed voice samples or utterances may be accepted by automatic speaker verification systems.

Current solutions for replay attacks include prompted speech approaches. In such prompted speech approaches, the automatic speaker verification system generates, for each authentication attempt, a random new phrase, which must be spoken by the user. Such solutions cause complexity as the automatic speaker verification system must recognize random phrases (without training). Furthermore, such solutions diminish user experience as the user must first identify the phase that is being requested by the system before making an authentication attempt.

As such, existing techniques do not provide protection against replay attacks without negatively impacting user experience and other problems. Such problems may become critical as the desire to utilize automatic speaker verification becomes more widespread in various implementations such as voice login.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is an illustrative diagram of an example setting for providing replay attack detection;

FIG. 2 is an illustrative diagram of an example system for providing replay attack detection;

FIG. 3 is an illustrative diagram of an example system for training mixture models for replay attack detection;

FIG. 4 is an illustrative diagram of an example system for providing replay attack detection;

FIG. 5 is an illustrative diagram of an example system for training a support vector machine for replay attack detection;

FIG. 6 is an illustrative diagram of an example system for providing replay attack detection;

FIG. 7 is a flow diagram illustrating an example process for automatic speaker verification;

FIG. 8 is an illustrative diagram of an example system for providing replay attack detection;

FIG. 9 is an illustrative diagram of an example system for providing training for replay attack detection;

FIG. 10 is an illustrative diagram of an example system; and

FIG. 11 illustrates an example device, all arranged in accordance with at least some implementations of the present disclosure.

### DETAILED DESCRIPTION

One or more embodiments or implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every embodiment may not necessarily include the particular feature, structure, or characteristic. Moreover, such phrases are not necessarily referring to the same implementation. Further, when a particular feature, structure, or characteristic is described in connection with an embodiment, it is submitted that it is within the knowledge of one skilled in the art to effect such feature, structure, or characteristic in connection with other implementations whether or not explicitly described herein.

Methods, devices, apparatuses, computing platforms, and articles are described herein related to automatic speaker verification and, in particular, to detecting replay attacks in automatic speaker verification systems.

As described above, replay attacks (e.g., replaying a secret recording of a person's voice to an automatic speaker verification system to gain improper access) may be easily performed and successful. It is advantageous to detect such replay attacks and to reject system access requests based on such detection. For example, systems without replay detection may be susceptible to imposter attacks, which may severely hinder the usefulness of such systems.

In some embodiments discussed herein, an utterance may be received from an automatic speaker verification system user. For example, the utterance may be an attempt to access a system. For example, it may be desirable to determine whether the utterance was issued by a person (e.g., an original utterance) or replayed via a device (e.g., a replay utterance). A replayed utterance may be provided in a replay attack for example. As used herein, the term utterance encompasses an utterance issued by a person to an automatic speaker verification system and an utterance replayed (e.g., via a device) to an automatic speaker verification system. Features associated with the utterance may be extracted. In some examples, the features are coefficients representing or based on a power spectrum of the utterance or a portion thereof. For example, the coefficients may be Mel frequency cepstrum coefficients (MFCCs) The utterance may be classified as a replayed utterance or an original utterance based on a statistical classification, a margin classification, or other classification (e.g., a discriminatively trained classification) of the utterance based on the extracted features.

For example, when the classification is based on the statistical classification, a score for the utterance may be determined based on a ratio of a log-likelihood the utterance was produced by a replay mixture model to a log-likelihood the utterance was produced by an original mixture model. In this context, the term “produced by” indicates a likelihood the utterance has similar characteristics as the utterances used to train the pertinent mixture model (e.g., replay or original). The mixture models may be Gaussian mixture models (GMMs) pre-trained based on many recordings of original utterances and replay utterances as is discussed further herein.

In examples where the classification is based on the margin classification, a maximum-a-posteriori adaptation of a universal background model based on the extracted features may be performed. The adaptation may generate an utterance mixture model. For example, the utterance mixture model may be a Gaussian mixture model. A super vector may be extracted based on the utterance mixture model. For example, the super vector may be extracted by concatenating mean vectors of the utterance mixture model. Based on the extracted super vector, a support vector machine may determine whether the utterance is a replay utterance or an original utterance. For example, the support vector machine may be pre-trained based on many recordings of original utterances and replayed utterances as is discussed further herein.

In either case, an utterance classified as a replay or replayed utterance may cause the automatic speaker verification system to deny access to the system. An utterance classified as an original utterance may cause the system to allow access and/or to further evaluate the utterance for user identification or other properties prior to allowing access to the system.

Such techniques, as implemented via an automatic speaker verification system may provide robust replay attack identification. For example, as implemented via modern computing systems, such techniques may provide error rates of less than 1.5% and, in some implementations, less than 0.2%.

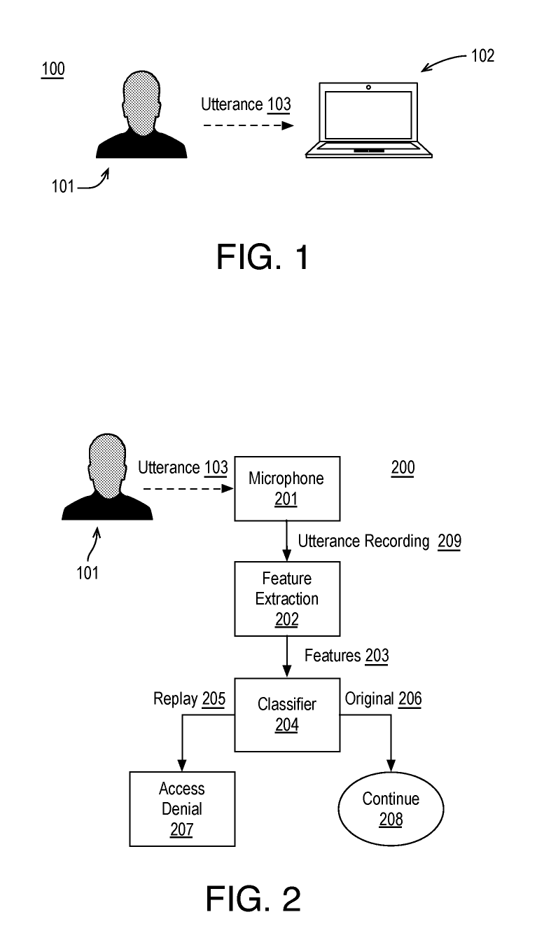

FIG. 1 is an illustrative diagram of an example setting 100 for providing replay attack detection, arranged in accordance with at least some implementations of the present disclosure. As shown in FIG. 1, setting 100 may include a user 101 providing an utterance 103 for evaluation by device 102. For example, device 102 may be locked and user 101 may be attempting to access device 102 via an automatic speaker verification system. If user 101 provides an utterance 103 that passes the security of device 102, device 102 may allow access or the like. For example, device 102 may provide a voice login to user 101. As shown, in some examples, an automatic speaker verification system may be implemented via device 102 to allow access to device 102. Furthermore, in some examples, device 102 may be a laptop computer. However, device 102 may be any suitable device such as a computer, a laptop, an ultrabook, a smartphone, a tablet, an automatic teller machine, or the like. Also, in the illustrated example, automatic speaker verification is being implemented to gain access to device 102 itself. In other examples, automatic speaker verification may be implemented via device 102 such that device 102 further indicates to other devices or equipment such as security locks, security indicators, or the like to allow or deny access to a room or area or the like. In such examples, device 102 may be a specialty security device for example. In any case, device 102 may be described as a computing device as used herein.

As shown, in some examples, user 101 may provide utterance 103 in an attempt to gain security access via device 102. As described, in some examples, user 101 may provide a replay utterance via a device (not shown) in an attempt to gain improper security access via device 102. In such examples, user 101 may be characterized as an intruder. As used herein, utterance 103 may include an utterance from user 101 directly (e.g., made vocally by user 101) or an utterance from a replay of a device. For example, the replay utterance may include a secretly recorded utterance made by a valid user. The replay utterance may be replayed via any device such as a smartphone, a laptop, a music player, a voice recorder, or the like.

As is described further herein, such replay attack utterances (e.g., replay utterances or the like) may be detected and device 102 may deny security access based on such detection. In some examples, such replay utterances (e.g., the speech or audio recordings) may contain information about the recording and replay equipment used to record/replay them. For example, the information may include frequency response characteristic of microphones and/or playback loudspeakers. Such information may be characterized as channel characteristics. For example, such channel characteristics may be associated with recording channels as influenced by recording and replay equipment as discussed. The techniques discussed herein may model and detect such channel characteristics based on statistical approaches including statistical classification, margin classification, discriminative classification, or the like using pre-trained models.

FIG. 2 is an illustrative diagram of an example system 200 for providing replay attack detection, arranged in accordance with at least some implementations of the present disclosure. As shown in FIG. 2, system 200 may include a microphone 201, a feature extraction module 202, a classifier module 204, and an access denial module 207. For example, as shown in FIG. 2, if classifier module 204 provides a replay indicator 205 (e.g., an indication utterance 103 is classified in a replay utterance class as discussed further herein), access denial module 207 may receive replay indicator 205 to deny access based on utterance 103. Furthermore, as shown in FIG. 2, if classifier module 204 provides an original indicator 206 (e.g., an indication utterance 103 is classified in an original utterance class), system 200 may continue evaluating utterance 103 (as illustrated via continue operation 208) for a user match or other characteristics to allow access to user 101. For example, user 101 may not gain security access solely based on utterance 103 being identified as an original recording.

As shown, microphone 201 may receive utterance 103 from user 101. In some examples, utterance 103 is issued by user 103 (e.g., utterance 103 is a true utterance vocally provided by user 101). In other examples, utterance 103 may be replayed via a device (not shown, e.g., utterance 103 is a replay utterance and a false attempt to gain security access). In such examples, user 101 may be an intruder as discussed. Microphone 201 may receive utterance 103 (e.g., as sound waves in the air) and convert utterance 103 to an electrical signal such as a digital signal to generate utterance recording 209. For example, utterance recording 209 may be stored in memory (not shown in FIG. 2).

Feature extraction module 202 may receive utterance recording from microphone 201 or from memory of system 200 and feature extraction module 202 may generate features 203 associated with utterance 103. Features 203 may be any suitable features representing utterance 103. For example, features 203 may be coefficients representing a power spectrum of the received utterance. In an embodiment, features 203 are Mel frequency cepstrum coefficients representing a power spectrum of the received utterance. In some examples, features 203 may be represented by a feature vector or the like. In some examples, features 203 may be based on an entirety of utterance 103 (and utterance recording 209). In other examples, features 203 may be based on a portion of utterance 103 (and utterance recording 209). For example, the portion may be a certain recording duration (e.g., 5, 3, or 0.5 seconds or the like) of utterance recording 209.

As discussed, features 203 may be any suitable features associated with utterance 103 such as coefficients representing a power spectrum of utterance 103. In an embodiment, features 203 are Mel frequency cepstrum coefficients. For example, Mel frequency cepstrum coefficients may be determined based on utterance 103 (e.g., via utterance recording 209) by taking a Fourier transform of utterance 103 or a portion thereof (e.g., via utterance recording 209), mapping to the Mel scale, determining logs of the powers at each Mel frequency, and determining the Mel frequency cepstrum coefficients based on a discrete cosine transform (DCT) of the logs of the powers. Feature extraction module 202 may transfer features 203 to classifier module 204 and/or to a memory of system 200.

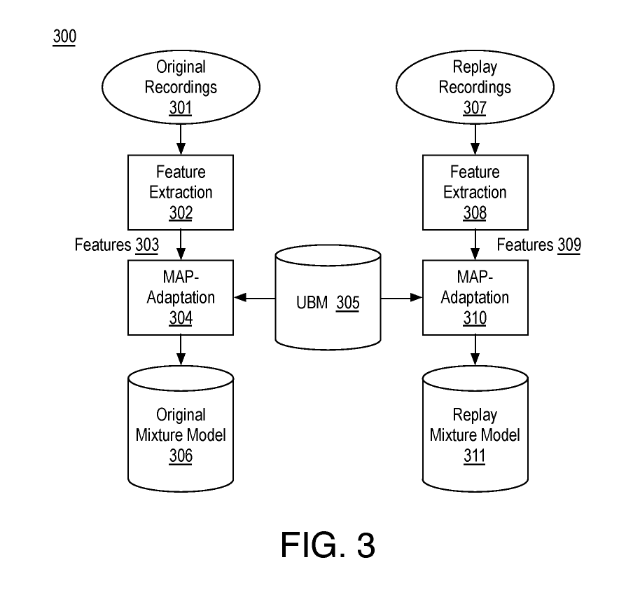

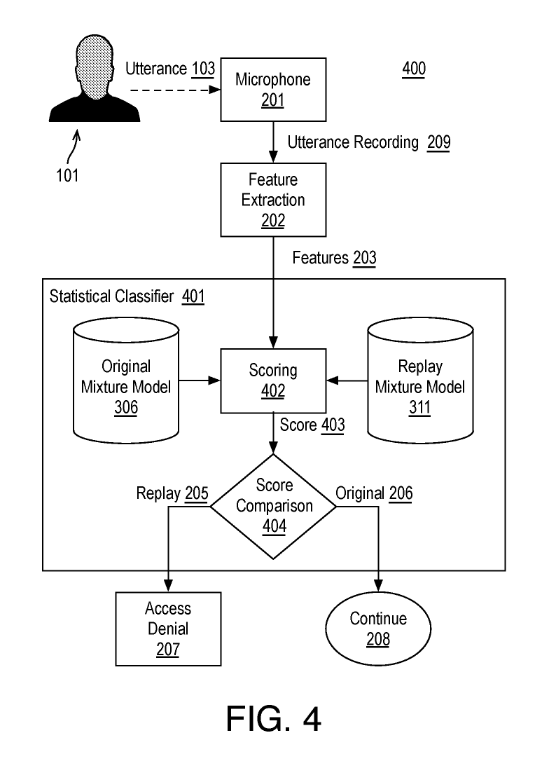

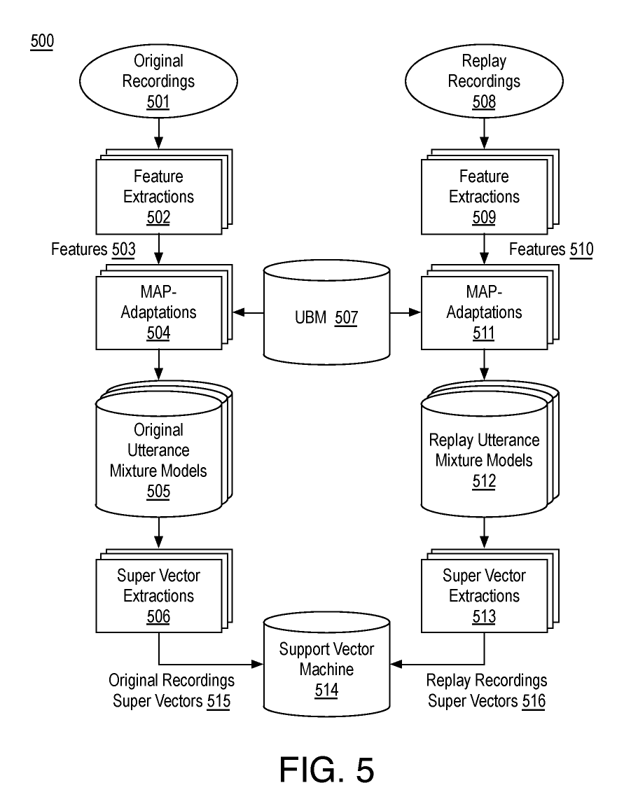

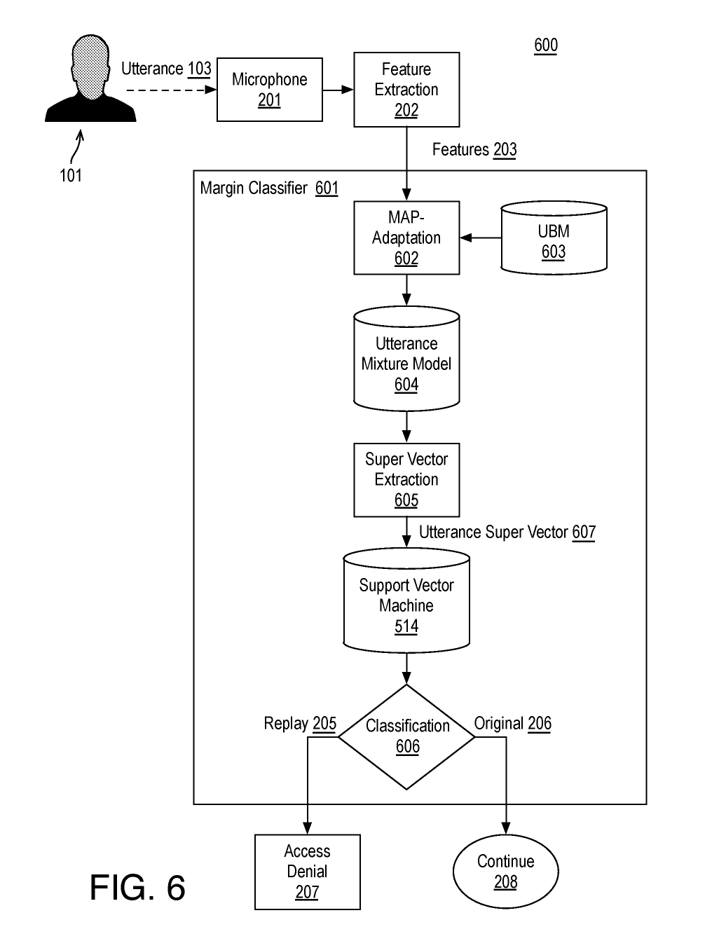

As shown in FIG. 2, features 203 may be received by classifier module 204 from feature extraction module 202 or memory of system 200. Classifier module 204 may classify utterance 103 in a replay utterance class or an original utterance class. Classifier module 204 may classify utterance 103 based on any suitable classification technique. In some examples, classifier module 204 may classify utterance 103 based on a statistical classification or a margin classification using (e.g., based on) features 203. However, classifier module 204 may use other classification techniques. For example, classifier module 204 may be a discriminatively trained classifier such as a maximum mutual information (MMI) classifier. Example statistical classifications are discussed further herein with respect to FIGS. 3 and 4 and example margin classifications are discussed further herein with respect to FIGS. 5 and 6.

Classifier module 204 may provide an indicator based on the classification of utterance 103. If utterance 103 is classified as an original utterance (e.g., utterance 103 is classified in an original utterance class such that classifier module 204 has determined utterance 103 was issued directly from user 101), classifier module 204 may generate original indicator 206. Original indicator 206 may include any suitable indication utterance 103 has been classified as an original utterance such as a bit of data or flag indicator, or the like. As shown via continue operation 208, system 200 may continue the evaluation of utterance 103 via speech recognition modules (not shown) or the like to identify user 101 and/or perform other tasks to (potentially) allow security access to user 101.

If utterance 103 is classified as a replay utterance (e.g., utterance 103 is classified in a replay utterance class such that classifier module 204 has determined utterance 103 was replayed via a device), classifier module 204 may generate replay indicator 205. Replay indicator 205 may include any suitable indication utterance 103 has been classified as a replay utterance such as a bit of data or flag indicator, or the like. As shown, replay indicator 205 may be transferred to access denial module 207 and/or a memory of system 200. Access denial module 207 may receive replay indicator 205 and may deny access to user 101 based on replay indicator 205 (e.g. based on utterance 103 being classified in a replay utterance class). For example, access denial module 207 may display to user 101 access has been denied via a display device (not shown) and/or prompt user 101 for another attempt to gain security access. In other examples, access denial module 207 may lock doors, activate a security camera, or take other security measures in response to replay indicator 205.

As discussed, in some examples, classifier module 204 may classify utterance 103 based on a statistical classification. Examples of a statistical classification are discussed with respect to FIGS. 3 and 4.

FIG. 3 is an illustrative diagram of an example system 300 for training mixture models for replay attack detection, arranged in accordance with at least some implementations of the present disclosure. For example, system 300 may generate an original mixture model 306 and a replay mixture model 311, which may be used for utterance classification as is discussed with respect to FIG. 4. In an embodiment, original mixture model 306 and replay mixture model 311 are Gaussian mixture models. For example, the training discussed with respect to FIG. 3 may be performed offline and prior to implementation while the classification discussed with respect to FIG. 4 may be performed in real-time via a security system or authentication system or the like. In some examples, system 300 and the system discussed with respect to FIG. 4 may be implemented by the same device and, in other examples, they may be implemented by different devices. In an embodiment, original mixture model 306 and replay mixture model 311 may be generated offline and may be propagated to many devices for use in real-time.

As shown in FIG. 3, system 300 may include a feature extraction module 302, a maximum-a-posteriori (MAP) adaptation module 304, a feature extraction module 308, a maximum-a-posteriori (MAP) adaptation module 310, and a universal background model (UBM) 305. As shown, system 300 may include or be provided original recordings 301 and replay recordings 307. For example, system 300 may generate original recorders 301 by recording utterances issued by users (e.g., via a microphone of system 300, not shown) or system 300 may receive original recordings 301 via a memory device or the like such that original recordings 301 were made via a different system. Furthermore, system 300 may include or be provided replay recordings 307. For example, system 300 may generate replay recordings 307 by recording utterances played by another device (e.g., via a microphone of system 300 receiving playback via a speaker of another device) or system 300 may receive replay recordings 307 via a memory device or the like such that replay recordings were made via a different system.

In any event, original recordings 301 are recordings of directly issued user utterances and replay recordings are recordings of user utterances being played back via a device speaker. In an example, users may issue utterances and system 300 may record the utterances to generate original recordings 301 and, concurrently, a separate device may record the utterances. The separately recorded utterances may subsequently be played back to system 300, which may then record replay recordings 307. Original recordings 301 and replay recordings 307 may include any number of recordings of any durations for training original mixture model 306 and replay mixture model 311. In some examples, original recordings and replay recordings 307 may each include hundreds or thousands or more recordings. In some examples, original recordings and replay recordings 307 may each include about 4,000 to 6,000 recordings. Furthermore, original recordings and replay recordings 307 may be made by any number of people such as 10, 12, 20, or more speakers. Original recordings and replay recordings 307 may be of any duration such as 0.5, 2, 3, or 5 seconds or the like. Original recordings and replay recordings 307 may provide a set of recordings for training original mixture model 306 and replay mixture model 311.

As shown, feature extraction module 302 may receive original recordings 301 (e.g., from memory or the like) and feature extraction module 302 may generate features 303. Features 303 may be any features associated with original recordings 301. In some examples, features 303 are coefficients that represent a power spectrum of original recordings 301 or a portion thereof. For example, features 303 may be generated for each original recording of original recordings 301. In an embodiment, features 303 are Mel cepstrum coefficients as discussed herein. Feature extraction module 302 may transfer features 303 to MAP-adaptation module 304 and/or to a memory (not shown) of system 300.

MAP-adaptation module 304 may receive features 303 from feature extraction module 302 or memory and MAP-adaptation module 304 may adapt universal background model (UBM) 305 to features 303 using (e.g., based on) a maximum-a-posteriori adaption of universal background model 305 to generate original mixture model 306. For example, original utterance mixture module 306 may be saved to memory for future implementation via the device implementing system 300 or another device. In an embodiment, original mixture model 306 is a Gaussian mixture model. For example, universal background model 305 may be a Gaussian mixture model trained offline based on a very large amount of speech data. In an example, universal background model 305 may be pre-built using a Gaussian mixture model expectation maximization algorithm.

Also as shown, feature extraction module 308 may receive replay recordings 307 (e.g., from memory or the like) and feature extraction module 308 may generate features 309. As discussed with respect to features 303, features 309 may be any suitable features associated with replay recordings 307. For example, features 309 may be coefficients that represent a power spectrum of replay recordings 307 or a portion thereof. For example, features 309 may be generated for each replay recording of replay recordings 307. In an embodiment, features 309 are Mel cepstrum coefficients as discussed herein. Feature extraction module 308 may transfer features 303 to MAP-adaptation module 310 and/or to a memory of system 300. MAP-adaptation module 310 may receive features 309 from feature extraction module 308 or memory and MAP-adaptation module 310 may adapt universal background model 305 to features 303 using (e.g., based on) a maximum-a-posteriori adaption of universal background model 305 to generate replay mixture model 311. For example, replay utterance mixture module 311 may be saved to memory for future implementation via the device implementing system 300 or another device. In an embodiment, replay mixture model 311 is a Gaussian mixture model.

As shown, in some examples, feature extraction modules 302, 308 may be implemented separately. In other examples, they may be implemented together via system 300. In some examples, feature extraction modules 302, 308 may be implemented via the same software module. Similarly, in some examples, MAP-adaptation modules 304, 310 may be implemented separately and, in other examples, they may be implemented together. As discussed, by implementing system 300, original mixture model 306 and replay mixture model 311 may be generated. By using the MAP-adaptation approach as discussed, original mixture model 306 and replay mixture model 311 may be robustly trained and may have corresponding densities. For example, after such training, two GMMs may be formed: original mixture model 306 representing original utterances (e.g., non-replay recordings) and replay mixture model 311 representing replay utterances (e.g., replay recordings).

FIG. 4 is an illustrative diagram of an example system 400 for providing replay attack detection, arranged in accordance with at least some implementations of the present disclosure.

As shown, system 400 may include microphone 201, feature extraction module 202, a statistical classifier 401, and access denial module 207. Furthermore, as shown via continue operation 208, system 400 may further evaluate utterances classified in an original utterance class for the security access of user 101. Microphone 201, feature extraction module 202, access denial module 207, and continue operation have been discussed with respect to FIG. 2 and such discussion will not be repeated for the sake of brevity.

As shown, statistical classifier 401 may include original mixture model 306, replay mixture model 311, a scoring module 402, and a score comparison module 404. Original mixture model 306 and replay mixture model 311 may include, for example, Gaussian mixture models. In some examples, statistical classifier 401 may implement a Gaussian classification and statistical classifier 401 may be characterized as a Gaussian classifier. Furthermore, original mixture model 306 and replay mixture model 311 may include pre-trained mixture models trained based on a set of original recordings (e.g., original recordings 301) and a set of replay recordings (e.g., replay recordings 307). As discussed, the recordings may include original recordings recorded via device (e.g., a first device) and replay recordings including replays of the original recordings replayed via another device (e.g., a second device) and recorded via the device (e.g., the first device). In some examples, original mixture model 306 and replay mixture model 311 may be stored in a memory (not shown) of system 400. In some examples, original mixture model 306 and replay mixture model 311 may be generated as discussed with respect to FIG. 3.

Furthermore, as discussed, statistical classifier 401 may include scoring module 402. As shown, scoring module 402 may receive features 203 from feature extraction module 202 or memory and scoring module 402 may determine a score 403, which may be transferred to score comparison module 404 and/or memory. Score 403 may include any suitable score or scores associated with a likelihood features 203 associated with utterance 103 are more strongly associated with original mixture model 306 or replay mixture model 311. In some examples, scoring module 402 may determine score 403 as a ratio of a log-likelihood the utterance was produced by replay mixture model 311 to a log-likelihood the utterance was produced by an original mixture model 306. In an example, score 403 may be determined as shown in Equation (1):

$$score ( Y ) = \frac{p ( Y \vert {GMM}_{REPLAY} )}{p ( Y \vert {GMM}_{ORIGINAL} )} \qquad ( 1 )$$

where score(Y) may be score 403, Y may be features 203 (e.g., a MFCC-sequence associated with utterance 103 and utterance recording 209), p may be a log-likelihood or a frame-wise log-likelihood (e.g., an evaluation of MFCC features over temporal frames such as 0.5, 1, 2, or 5 seconds or the like of utterance 103 and utterance recording 209) summation, GMM_{REPLAY} may be replay mixture model 311, GMM_{ORIGINAL} may be original mixture model 306. For example, p(Y|GMM_{REPLAY}) may be a log-likelihood utterance 103 was produced by (or built by) replay mixture model 311 and p(Y|GMM_{ORIGINAL}) may be a log-likelihood utterance 103 was produced by (or built by) original mixture model 306. In this context, the terms “produced by” or “built by” indicate a likelihood the utterance has similar characteristics as the utterances used to train the pertinent mixture model (e.g., replay or original).

As shown in FIG. 4, score 403 may be received by score comparison module 404 from scoring module 402 or memory. Score comparison module 404 may determine whether utterance 103 is in a replay utterance class or an original utterance class based on a comparison of score 403 to a predetermined threshold. In some examples, if score 403 is greater than (or greater than or equal to) the predetermined threshold, utterance 103 may be classified as a replay utterance if score 403 is less than (or less than or equal to) the predetermined threshold, utterance 103 may be classified as an original utterance. In some examples, the comparison of score 403 to the predetermined threshold may be determined as shown in Equation (2):

$$score ( Y ) \{ \begin{matrix}\geq θ ( Y = REPLAY ) \\ < θ ( Y = ORIGINAL )\end{matrix} \qquad ( 2 )$$

where θ may be the predetermined threshold, REPLAY may be the replay class, and ORIGINAL may be the original utterance class. As shown, in an example, if score(Y) is greater than or equal to the predetermined threshold, utterance 103 may be classified in the replay utterance class and if score (Y) is less than the predetermined threshold, utterance 103 may be classified in the original utterance class. For example, the predetermined threshold may be determined offline based on the training of original mixture model 306 and replay mixture model 311.

As discussed, statistical classifier 401 may classify utterance 103 in a replay utterance class or an original utterance class. When statistical classifier 401 classifies utterance 103 in the replay utterance class, score comparison module 404 may generate replay indicator 205, which, as discussed, may be transferred to access denial module 207 and/or memory. Access denial module 207 may deny access to user 101 and/or take further security actions based on replay indicator 205. When statistical classifier 401 classifies utterance 103 in the original utterance class, score comparison module 404 may generate original indicator 206, which, as discussed, may indicate, via continue operation 208, further evaluation of utterance 103 by system 400. Also as discussed, statistical classifier 401 may classify utterance 103 based on original mixture model 306 and replay mixture model 311 such that original mixture model 306 and replay mixture model 311 are Gaussian mixture models. In such examples, statistical classifier 401 may be characterized as a Gaussian classifier.

With reference to FIG. 2, as discussed, in some examples, classifier module 204 may classify utterance 103 based on a marginal classification. Examples of a marginal classification are discussed with respect to FIGS. 5 and 6.

FIG. 5 is an illustrative diagram of an example system 500 for training a support vector machine for replay attack detection, arranged in accordance with at least some implementations of the present disclosure. For example, system 500 may generate a support vector machine 514, which may be used for utterance classification as is discussed with respect to FIG. 6. For example, the training discussed with respect to FIG. 5 may be performed offline and prior to implementation while the classification discussed with respect to FIG. 6 may be performed in real-time. In some examples, system 500 and the system discussed with respect to FIG. 6 may be implemented by the same device and, in other examples, they may be implemented by different devices. In an embodiment, support vector machine 514 may be generated offline and may be propagated to many devices for use in real-time.

As shown in FIG. 5, system 500 may include a feature extractions module 502, a maximum-a-posteriori (MAP) adaptations module 504, a super vector extractions module 506, a feature extractions module 509, a maximum-a-posteriori (MAP) adaptations module 511, and a super vector extractions module 513. As shown, system 500 may include or be provided original recordings 501 and replay recordings 508. For example, system 500 may generate original recorders 501 and replay recordings 508 or system 500 may receive original recordings 301 and replay recordings 508 as discussed with respect to original recordings 301, replay recordings 307, and system 300. Original recordings 501 and replay recordings 508 may have any attributes as discussed herein with respect to original recordings 301 and replay recordings 307, respectively, and such discussion will not be repeated for the sake of brevity. Original recordings 501 and replay recordings 508 may provide a set of recordings for training support vector machine 514.

As shown, feature extractions module 502 may receive original recordings 501 (e.g., from memory or the like) and feature extractions module 502 may generate features 503. Features 503 may be any features associated with original recordings 501a portion thereof. For example, features 503 may include coefficients that represent a power spectrum of original recordings 501 or a portion thereof. For example, features 503 may be generated for each original recording of original recordings 501. In an embodiment, features 503 are Mel cepstrum coefficients as discussed herein. Feature extractions module 502 may transfer features 503 to MAP-adaptations module 504 and/or to a memory (not shown) of system 500. In an example, features 503 may include a set of coefficients with each set being associated with an original recording of original recordings 501.

MAP-adaptations module 504 may receive features 503 from feature extractions module 502 or memory. As discussed, features 503 may include a set of features or coefficients or the like for each of original recordings 501. MAP-adaptations module 504 may, based on each set of coefficients, adapt a universal background model (UBM) 507 using (e.g., based on) a maximum-a-posteriori adaption of universal background model 507 to generate original utterance mixture models 505 (e.g., including an original utterance mixture model for each set of features or coefficients of features 503). For example, universal background model 507 may be a Gaussian mixture model trained offline based on a very large amount of speech data. In an example, universal background model 507 may be pre-built using a Gaussian mixture model expectation maximization algorithm.

In FIG. 5, the multiple instances of MAP-adaptations module 504 and other similarly illustrated modules (e.g., modules 502, 505, 506, 509, 511, 512, 513) are meant to indicate the operation associated therewith (or the memory item associated therewith) is performed for each instance of a recording in the set of recordings (e.g., original recordings 501 and replay recordings 508). For example, as discussed, a MAP-adaptation of universal background model 507 may be performed for each set of features or coefficients to generate an original utterance mixture model, and, as discussed below, an associated super vector (e.g., of original recordings super vectors 515) may be generated for each original utterance mixture model. Similarly, for replay recordings 508, features 510 may include a set of features or coefficients for each replay recording, MAP-adaptations module 511 may generate a replay utterance mixture model for each set of coefficients, and super vector extractions model 513 may generate a replay recording super vector (e.g., of replay recordings super vectors 516) for each replay utterance mixture model. Thereby, multiple original recordings super vectors 515 and multiple replay recordings super vectors 516 may be provided to support vector machine 514 training. As shown, MAP-adaptations module 504 may transfer original utterance mixture models 505 to super vector extractions module 506 and/or to a memory (not shown) of system 500.

Super vector extractions module 506 may receive original utterance mixture models 505 from MAP-adaptations module 504 or a memory of system 500. Super vector extractions module 506 may, for each original utterance mixture model of original utterance mixture models 505, extract an original recording super vector to generate original recordings super vectors 515 having multiple extracted super vectors, one for each original utterance mixture model. Super vector extractions module 506 may generate original recordings super vectors 515 using any suitable technique or techniques. In an example, super vector extractions module 506 may generate each original recording super vector by concatenating mean vectors of each original utterance mixture model. For example, each original utterance mixture model may have many mean vectors and each original recording super vector may be formed by concatenating them. Super vector extractions module 506 may transfer original recordings super vectors 515 to support vector machine 514 and/or to a memory of system 514.

Also as shown in FIG. 5, feature extractions module 509 may receive replay recordings 508 (e.g., from memory or the like) and feature extractions module 509 may generate features 510. Features 510 may be any features associated with replay recordings 508. For example, features 510 may include coefficients that represent a power spectrum of replay recordings 509 and, for example, features 510 may be generated for each replay recording of replay recordings 508. In an embodiment, features 510 are Mel cepstrum coefficients as discussed herein. Feature extractions module 509 may transfer features 510 to MAP-adaptations module 511 and/or to a memory of system 500. As discussed with respect to features 503, features 510 may include a set of coefficients for each of replay recordings 501.

MAP-adaptations module 511 may receive features 510 from feature extractions module 509 or memory. MAP-adaptations module 511 may, based on each set of coefficients, adapt universal background model 507 using (e.g., based on) a maximum-a-posteriori adaption of universal background model 507 to generate replay utterance mixture models 512 (e.g., including a replay utterance mixture model for each set of coefficients of features 510). As shown, MAP-adaptations module 511 may transfer replay utterance mixture models 512 to super vector extractions module 513 and/or to a memory of system 500.

Super vector extractions module 513 may receive original utterance mixture models 512 from MAP-adaptations module 511 or a memory of system 500. Super vector extractions module 513 may, for each replay utterance mixture model of replay utterance mixture models 512, extract a replay recording super vector to generate replay recordings super vectors 516 having multiple extracted super vectors, one for each replay utterance mixture model. Super vector extractions module 513 may generate replay recordings super vectors 516 using any suitable technique or techniques. In an example, super vector extractions module 513 may generate each replay recording super vector by concatenating mean vectors of each replay utterance mixture model. For example, each replay utterance mixture model may have many mean vectors and each replay recording super vector may be formed by concatenating them. Super vector extractions module 513 may transfer replay recordings super vectors 516 to support vector machine 514 and/or to a memory of system 514.

Support vector machine 514 may receive original recordings super vectors 515 from super vector extractions module 506 or memory and replay recordings super vectors 516 from super vector extractions module 513 or memory. Support vector machine 514 may be trained based on original recordings super vectors 515 and replay recordings super vectors 516. For example, support vector machine 514 may model the differences or margins between original recordings super vectors 515 and replay recordings super vectors 516 (e.g., between the two classes). For example, support vector machine 514 may exploit the differences between original recordings super vectors 515 and replay recordings super vectors 516 to discriminate based on received super vectors during a classification implementation. Support vector machine 514 may be trained abased on being provided original recordings super vectors 515 and replay recordings super vectors 516 and which class (e.g., original or replay) each belongs to. Support vector machine 514 may, based on such information, generating weightings for various parameters, which may be stored for use in classification.

FIG. 6 is an illustrative diagram of an example system 600 for providing replay attack detection, arranged in accordance with at least some implementations of the present disclosure. As shown, system 600 may include microphone 201, feature extraction module 202, a margin classifier 601, and access denial module 207. Furthermore, as shown via continue operation 208, system 600 may further evaluate utterances classified in an original utterance class for the security access of user 101. Microphone 201, feature extraction module 202, access denial module 207, and continue operation have been discussed with respect to FIG. 2 and such discussion will not be repeated for the sake of brevity.

As shown, margin classifier 601 may include a maximum-a-posteriori (MAP) adaptation module 602, a universal background model (UBM) 603, a super vector extraction module 605, a super vector machine 514, and a decision module 606. Universal background model 603 may be a Gaussian mixture model trained offline based on a very large amount of speech data, for example. In an example, universal background model 603 may be pre-built using a Gaussian mixture model expectation maximization algorithm. Furthermore, support vector machine 514 may include a pre-trained support vector machine trained based on a set of original recordings (e.g., original recordings 501) and a set of replay recordings (e.g., replay recordings 508). As discussed, the recordings may include original recordings recorded via device (e.g., a first device) and replay recordings including replays of the original recordings replayed via another device (e.g., a second device) and recorded via the device (e.g., the first device). In some examples, universal background model 603 and/or support vector machine 514 may be stored in a memory (not shown) of system 600. In some examples, support vector machine 514 may be generated as discussed with respect to FIG. 4.

As discussed, margin classifier 601 may include MAP-adaptation module 602. As shown, MAP-adaptation module 602 may receive features 203 from feature extraction module 202 or memory and universal background model 603 from memory. MAP-adaptation module 602 may perform a maximum-a-posteriori adaptation of universal background model 603 based on features 203 (e.g., any suitable features such as coefficients representing the power spectrum of utterance 103) to generate utterance mixture model 604. In an embodiment, utterance mixture model 604 is a Gaussian mixture model. MAP-adaptation module 602 may transfer utterance mixture model 604 to support vector extraction module 605 and/or to memory.

Support vector extraction module 605 may receive utterance mixture model 604 from MAP-adaptation module 602 or memory. Support vector extraction module 605 may extract utterance super vector 607 based on utterance mixture model 604. Support vector extraction module 605 may extract utterance super vector 607 using any suitable technique or techniques. In an embodiment, support vector extraction module 605 may extract utterance super vector 607 by concatenating mean vectors of utterance mixture model 604. As shown, super vector extraction module 605 may transfer utterance super vector 607 to support vector machine 514 and/or to a memory of system 600.

Support vector machine 514 may receive utterance super vector 607 from super vector extraction module 605 or memory. Support vector machine 514 may determine whether utterance 103 is in a replay utterance class or an original utterance class based on utterance super vector 607. For example, support vector machine 514 may be pre-trained as discussed with respect to FIG. 5 to determine whether utterance 103 is more likely to be in an original utterance class or a replay utterance class based on a classification using (e.g., based on) utterance super vector 607. Classification module 606 may classify utterance 103 in a replay utterance classification or an original utterance classification based on input from support vector machine 514.

In some examples, support vector machine 514 may only operate on super vectors (e.g., utterance super vector 607) of the same length. In such examples, MAP-adaptation module 602 and/or super vector extraction module 605 may operate to provide a predetermined length of utterance super vector 607. For example, MAP-adaptation module 602 and/or super vector extraction module 605 may limit the size of utterance super vector 607 by removing beginning and/or end portions of data or the like.

As discussed, margin classifier 601 may classify utterance 103 in a replay utterance class or an original utterance class. When margin classifier 601 classifies utterance 103 in the replay utterance class, classification module 606 may generate replay indicator 205, which, as discussed, may be transferred to access denial module 207 and/or memory. Access denial module 207 may deny access to user 101 and/or take further security actions based on replay indicator 205. When margin classifier 601 classifies utterance 103 in the original utterance class, classification module 606 may generate original indicator 206, which, as discussed, may indicate, via continue operation 208, further evaluation of utterance 103 by system 400.

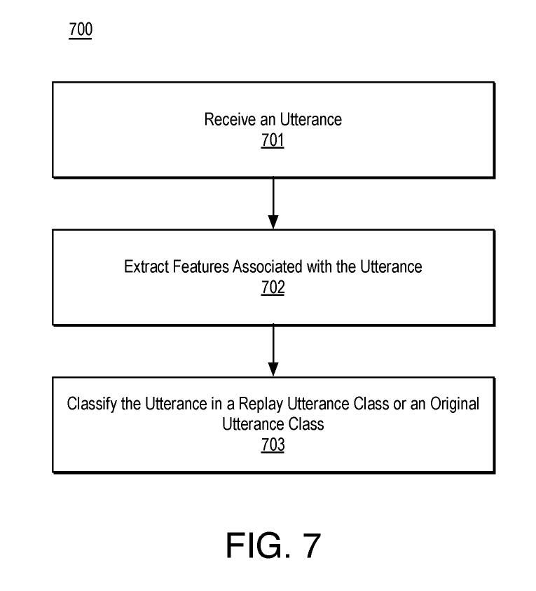

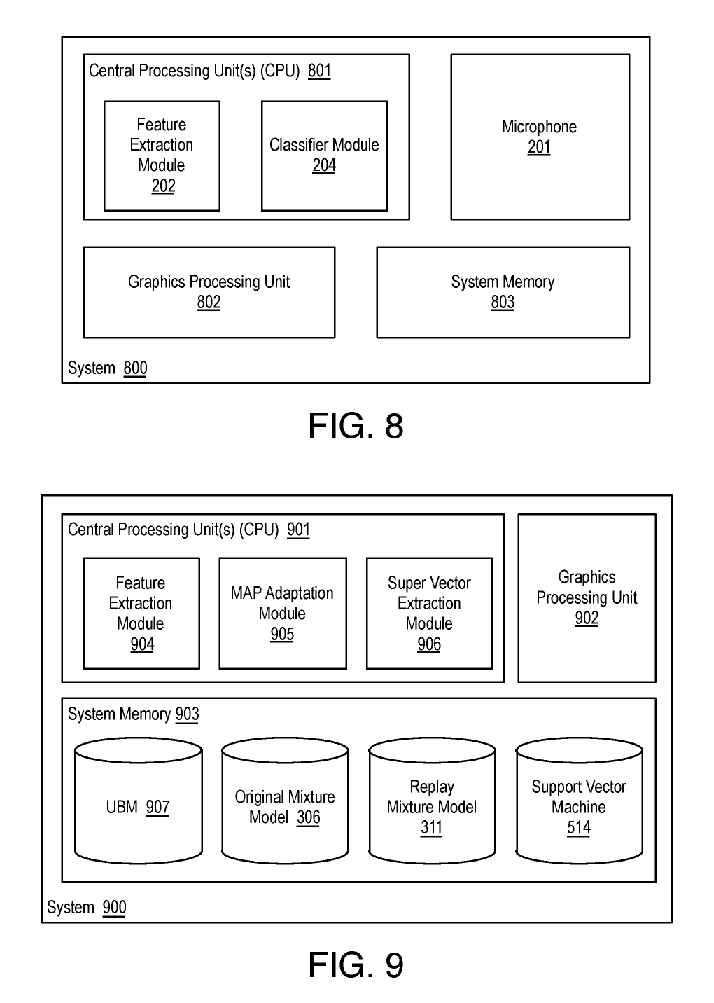

FIG. 7 is a flow diagram illustrating an example process 700 for automatic speaker verification, arranged in accordance with at least some implementations of the present disclosure. Process 700 may include one or more operations 701-703 as illustrated in FIG. 7. Process 700 may form at least part of a automatic speaker verification process. By way of non-limiting example, process 700 may form at least part of a automatic speaker verification classification process for an attained utterance such as utterance 103 as undertaken by systems 200, 400, or 600 as discussed herein. Further, process 700 will be described herein in reference to system 800 of FIG. 8.

FIG. 8 is an illustrative diagram of an example system 800 for providing replay attack detection, arranged in accordance with at least some implementations of the present disclosure. As shown in FIG. 8, system 800 may include one or more central processing units (CPU) 801, a graphics processing unit (GPU) 802, system memory 803, and a microphone 201. Also as shown, CPU 801 may include feature extraction module 202 and classifier module 204. In the example of system 800, system memory 803 may store automatic speaker verification data such as utterance recording data, features, coefficients, replay or original indicators, universal background models, mixture models, scores, super vectors, support vector machine data, or the like as discussed herein. Microphone 201 may include any suitable device or devices that may receive utterance 103 (e.g., as sound waves in the air, please refer to FIG. 1) and convert utterance 103 to an electrical signal such as a digital signal. In an embodiment, microphone converts utterance 103 to utterance recording 209. In an embodiment, utterance recording 209 may be stored in system memory for access by CPU 801.

CPU 801 and graphics processing unit 802 may include any number and type of processing units that may provide the operations as discussed herein. Such operations may be implemented via software or hardware or a combination thereof. For example, graphics processing unit 802 may include circuitry dedicated to manipulate data obtained from system memory 803 or dedicated graphics memory (not shown). Furthermore, central processing units 801 may include any number and type of processing units or modules that may provide control and other high level functions for system 800 as well as the operations as discussed herein. System memory 803 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, system memory 803 may be implemented by cache memory. As shown, in an embodiment, feature extraction module 202 and classifier module 204 may be implemented via CPU 801. In some examples, feature extraction module 202 and/or classifier module 204 may be provided by software as implemented via CPU 801. In other examples, feature extraction module 202 and/or classifier module 204 may be implemented via a digital signal processor or the like. In another embodiment, feature extraction module 202 and/or classifier module 204 differencer module 103 may be implemented via an execution unit (EU) of graphics processing unit 802. The EU may include, for example, programmable logic or circuitry such as a logic core or cores that may provide a wide array of programmable logic functions.

In some examples, classifier module 204 may implement statistical classifier 401 or margin classifier 601 or both. For example, classifier module 204 may implement scoring module 402 and/or score comparison module 404 and original mixture model 306 and replay mixture model 311 may be stored in system memory 803. In such examples, system memory 803 may also store score 403. In another example, classifier module 204 may implement MAP-adaptation module 602, super vector extraction module 605, support vector machine 514, and classification module 606 and universal background model 603 and portions of support vector machine 514 may be stored in system memory 803. In such examples, system memory 803 may also store utterance mixture model 604 and utterance super vector 607.

Returning to discussion of FIG. 7, process 700 may begin at operation 701, “Receive an Utterance”, where an utterance may be received. For example, utterance 803 (either originally spoken by user 101 or improperly played back by user 101 via a device) may be received via microphone 201. As discussed, microphone 201 and/or related circuitry may convert utterance 803 to utterance recording 209.

Processing may continue at operation 702, “Extract Features Associated with the Utterance”, where features associated with at least a portion of the received utterance may be extracted. For example, feature extraction module 202 as implemented via CPU 801 may extract features associated with utterance 103 such as Mel frequency cepstrum coefficients representing a power spectrum of utterance 103 (and utterance recording 209).

Processing may continue at operation 703, “Classify the Utterance in a Replay Utterance Class or an Original Utterance Class”, where the utterance may be classified in a replay utterance class or an original utterance class. For example, the utterance may be classified in the replay utterance class or the original utterance class based on at least one of a statistical classification, a margin classification, a discriminative classification, or the like of the utterance based on the extracted features associated with the utterance. For example, classifier module 204 may classify utterance 103 in a replay utterance class or an original utterance class as discussed herein.

In examples where a statistical classification is implemented, classifying the utterance may include determining (e.g., via scoring module 402 of statistical classifier 401 as implemented by CPU 801) a score for the utterance as a ratio of a log-likelihood the utterance was produced by a replay mixture model to a log-likelihood the utterance was produced by an original mixture model and determining (e.g., via score comparison module 404 of statistical classifier 401 as implemented by CPU 801) whether the utterance is in the replay utterance class or the original utterance class based on a comparison of the score to a predetermined threshold.

In examples where a margin classification is implemented, classifying the utterance may include performing (e.g., via MAP-adaptation module 602 of margin classifier 601 as implemented by CPU 801) a maximum-a-posteriori adaptation of a universal background model based on the extracted features to generate an utterance mixture model, extracting (e.g., via super vector extraction module 605 of margin classifier 601 as implemented by CPU 801) an utterance super vector based on the utterance mixture model, and determining, via a support vector machine (e.g., via support vector machine 514 of margin classifier 601 as implemented by CPU 801 and/or system memory 803), whether the utterance is in the replay utterance class or the original utterance class based on the super vector.

Process 700 may be repeated any number of times either in series or in parallel for any number of utterances received via a microphone. Process 700 may provide for utterance classification via a device such as device 102 as discussed herein. Also as discussed herein, prior to such classifying in real-time, various component of statistical classifier 401 and/or margin classifier 601 may be pre-trained via, in some examples, a separate system.

FIG. 9 is an illustrative diagram of an example system 900 for providing training for replay attack detection, arranged in accordance with at least some implementations of the present disclosure. As shown in FIG. 9, system 900 may include one or more central processing units (CPU) 901, a graphics processing unit (GPU) 902, and system memory 903. Also as shown, CPU 901 may include a feature extraction module 904, a MAP adaptation module 905, and super vector extraction module 906. In the example of system 900, system memory 903 may store automatic speaker verification data such as universal background model (UBM) 907, original mixture model 306, replay mixture model 311, and/or support vector machine 514, or the like. For example, universal background model 907 may include universal background model 305 and/or universal background model 507.

CPU 901 and graphics processing unit 902 may include any number and type of processing units that may provide the operations as discussed herein. Such operations may be implemented via software or hardware or a combination thereof. System memory 903 may be any type of memory such as volatile memory (e.g., Static Random Access Memory (SRAM), Dynamic Random Access Memory (DRAM), etc.) or non-volatile memory (e.g., flash memory, etc.), and so forth. Various components of the systems described herein may be implemented in software, firmware, and/or hardware and/or any combination thereof. For example, various components of systems 300 or 500 may be implemented, at least in part, by system 900. In some examples, system 900 may provide offline pre-training for statistical classification or margin classification as discussed herein.

In an example of pre-training for statistical classification, feature extraction module 904 may implement feature extraction module 302 and feature extraction module 308 either together or separately (please refer to FIG. 3). For example, feature extraction module 302 and feature extraction module 308 as implemented via CPU 901 may extract a plurality of original recording features based on original recordings and a plurality of replay recording features based on replayed recordings. As discussed, the original recordings and replay recordings may be generated by system 900 or received at system 900. In some examples, the original recordings and the replay recordings may also be stored in system memory 903. Furthermore, MAP adaptation module 905 may implement MAP-adaptation module 304 and MAP-adaptation module 310 (please refer to FIG. 3). For example, MAP-adaptation module 304 as implemented via CPU 901 may adapt a universal background model (e.g., universal background model 305) to original recording features (e.g., features 303) based on a maximum a posteriori adaption of the universal background model to generate the original mixture model (e.g., original mixture model 306) and MAP-adaptation module 310 as implemented via CPU 901 may adapt a universal background model (e.g., universal background model 305) to a plurality of replay recording features (e.g., features 309) based on a maximum a posteriori adaption of the universal background model to generate the replay mixture model (e.g., replay mixture model 311).

In an example of pre-training for margin classification, feature extraction module 904 may implement feature extractions module 502 and feature extractions module 509 either together or separately (please refer to FIG. 5). For example, feature extractions module 502 and feature extractions module 509 as implemented via CPU 901 may determine a plurality of sets of replay recording features based on the replayed recordings and a plurality of sets original recording features based on the original recordings. Furthermore, map adaptation module 905 may implement MAP-adaptations module 504 and MAP-adaptations module 511 (please refer to FIG. 5). MAP-adaptations module 504 as implemented via CPU 901 may adapt a universal background model (e.g., universal background model 305) to each of the plurality of sets of original recording coefficients (e.g., features 503) based on a maximum a posteriori adaption of the universal background model to generate a plurality of original utterance mixture models (e.g., original utterance mixture models 505 and MAP-adaptations module 511 as implemented via CPU 901 may adapt a universal background model (e.g., universal background model 305) to each of the plurality of sets of replay recording coefficients (e.g., features 510) based on a maximum a posteriori adaption of the universal background model to generate a plurality of replay utterance mixture models (e.g., original utterance mixture models 512). Furthermore, super vector extraction module 906 may implement super vector extractions module 506 and super vector extractions module 513. For example, super vector extractions module 506 as implemented via CPU 901 may extract original recording super vectors from original utterance mixture models 505 to generate original recordings super vectors 515 and super vector extractions module 513 as implemented via CPU 901 may extract replay recording super vectors from replay utterance mixture models 512 to generate replay recordings super vectors 516. Lastly, super vector machine 514 may be trained via CPU 901 based on the original and replay recordings super vectors as discussed herein.

While implementation of the example processes discussed herein may include the undertaking of all operations shown in the order illustrated, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of systems 200, 300, 400, 500, 600, 800, or 900, or any other module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As discussed, techniques discussed herein, as implemented via an automatic speaker verification system may provide robust replay attack identification. For example, as implemented via modern computing systems, such techniques may provide error rates of less than 1.5% and, in some implementations, less than 0.2%.

In an example implementation, a dataset of 4,620 utterances by 12 speakers with simultaneous recordings by multiple devices (e.g., an ultrabook implementing the automatic speaker verification system, a first smartphone (secretly) capturing/recording and replaying the utterances, and a second smartphone (secretly) capturing/recording and replaying the utterances) was created. In the example implementation, the recording length was between 0.5 and 2 seconds. As discussed, the ultrabook in this implementation was the device a user would attempt authenticate to (e.g., the ultrabook implemented the automatic speaker verification system). The first and second smartphones were used to capture (e.g., as would be secretly done in a replay attack) the user's voice (e.g., utterance). The recordings by the first and second smartphones were then replayed to the ultrabook. Thereby, a dataset of original recordings (e.g., directly recorded by the ultrabook) and replay recordings (e.g., played back by the first or second smartphone and recorded by the ultrabook) were generated. In this implementation, the training was performed in a Leave-One-Speaker-Out (LOO) manner (e.g., a leave one error out manner). By this, we assure a speaker independent evaluation. The results of two systems (e.g., a first system using the statistical classification as described with respect to FIG. 4 and a second system using the marginal classification as described with respect tot FIG. 6) are shown in Table 1. As shown, Table 1 contains the false positive (FP) rate (e.g., how many utterances have been falsely classified as replay recordings) and the true negative (TN) rate (e.g., how many utterances have been falsely classified as original recordings). Furthermore, Table 1 includes an error rate (ER) as the mean value of FP and TN.

TABLE 1
Example Results of an Implementation of Statistical
Classifications and Marginal Classifications

| System | Test | FP | TN | ER |
|---|---|---|---|---|
| Statistical Classification | Smartphone 1 | 1.43% | 0% | 0.75% |
| with GMM | | | | |
| Statistical Classification | Smartphone 2 | 1.43% | 1.39% | 1.41% |
| with GMM | | | | |
| Marginal Classification | Smartphone 1 | 0.28% | 0.06% | 0.17% |
| with SVM | | | | |
| Marginal Classification | Smartphone 2 | 0.28% | 0.04% | 0.16% |
| with SVM | | | | |

As shown in Table 1, the statistical classification system with GMM (Gaussian mixture models, as described with respect to systems 300 and 400 herein) and the marginal classification system with SVM (support vector machine, as described with respect to systems 500 and 600 herein) may provide excellent false positive, true negative, and overall error rates for detecting replay attacks. Furthermore, Table 1 shows the marginal classification system with SVM may provide higher accuracy in some system implementations.

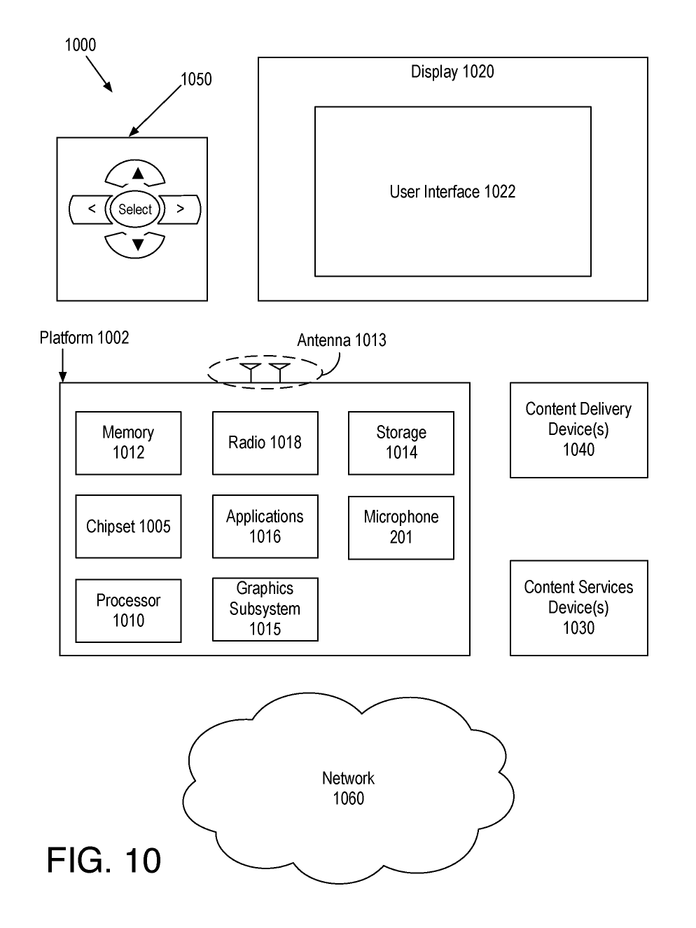

FIG. 10 is an illustrative diagram of an example system 1000, arranged in accordance with at least some implementations of the present disclosure. In various implementations, system 1000 may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1000 includes a platform 1002 coupled to a display 1020. Platform 1002 may receive content from a content device such as content services device(s) 1030 or content delivery device(s) 1040 or other similar content sources. As shown, in some examples, system 1000 may include microphone 201 implemented via platform 1002. Platform 1002 may receive utterances such as utterance 103 via microphone 201 as discussed herein. A navigation controller 1050 including one or more navigation features may be used to interact with, for example, platform 1002 and/or display 1020. Each of these components is described in greater detail below.

In various implementations, system 1000 may, in real time, provide automatic speaker verification operations such as replay attack detection as described. For example, such real time presentation may be provide security screening for a device or environment as described. In other implementations, system 1000 may provide for training of mixture models or support vector machines as described. Such training may be performed offline prior to real classification as discussed herein.

In various implementations, platform 1002 may include any combination of a chipset 1005, processor 1010, memory 1012, antenna 1013, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1010 may be dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1014 may include technology to increase the storage performance enhanced protection for valuable digital media when multiple hard drives are included, for example.

Graphics subsystem 1015 may perform processing of images such as still or video for display. Graphics subsystem 1015 may be a graphics processing unit (GPU) or a visual processing unit (VPU), for example. An analog or digital interface may be used to communicatively couple graphics subsystem 1015 and display 1020. For example, the interface may be any of a High-Definition Multimedia Interface, DisplayPort, wireless HDMI, and/or wireless HD compliant techniques. Graphics subsystem 1015 may be integrated into processor 1010 or chipset 1005. In some implementations, graphics subsystem 1015 may be a stand-alone device communicatively coupled to chipset 1005.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 1018 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In various implementations, display 1020 may include any television type monitor or display. Display 1020 may include, for example, a computer display screen, touch screen display, video monitor, television-like device, and/or a television. Display 1020 may be digital and/or analog. In various implementations, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In various implementations, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In various implementations, content services device(s) 1030 may include a cable television box, personal computer, network, telephone, Internet enabled devices or appliance capable of delivering digital information and/or content, and any other similar device capable of uni-directionally or bi-directionally communicating content between content providers and platform 1002 and/display 1020, via network 1060 or directly. It will be appreciated that the content may be communicated uni-directionally and/or bi-directionally to and from any one of the components in system 1000 and a content provider via network 1060. Examples of content may include any media information including, for example, video, music, medical and gaining information, and so forth.

Content services device(s) 1030 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1002 may receive control signals from navigation controller 1050 having one or more navigation features. The navigation features of controller 1050 may be used to interact with user interface 1022, for example. In various embodiments, navigation controller 1050 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1050 may be replicated on a display (e.g., display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022, for example. In various embodiments, controller 1050 may not be a separate component but may be integrated into platform 1002 and/or display 1020. The present disclosure, however, is not limited to the elements or in the context shown or described herein.

In various implementations, drivers (not shown) may include technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 even when the platform is turned “off.” In addition, chipset 1005 may include hardware and/or software support for 5.1 surround sound audio and/or high definition 7.1 surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002 and display 1020 may be an integrated unit. Display 1020 and content service device(s) 1030 may be integrated, or display 1020 and content delivery device(s) 1040 may be integrated, for example. These examples are not meant to limit the present disclosure.

In various embodiments, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information and control information, Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth, Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

As described above, system 1000 may be embodied in varying physical styles or form factors. FIG. 15 illustrates implementations of a small form factor device 1500 in which system 1500 may be embodied. In various embodiments, for example, device 1500 may be implemented as a mobile computing device a having wireless capabilities. A mobile computing device may refer to any device having a processing system and a mobile power source or supply, such as one or more batteries, for example. In some examples, device 1500 may include a microphone (e.g., microphone 201) and/or receive utterances (e.g., utterance 103) for real time replay attack detection for automatic speaker verification as discussed herein.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

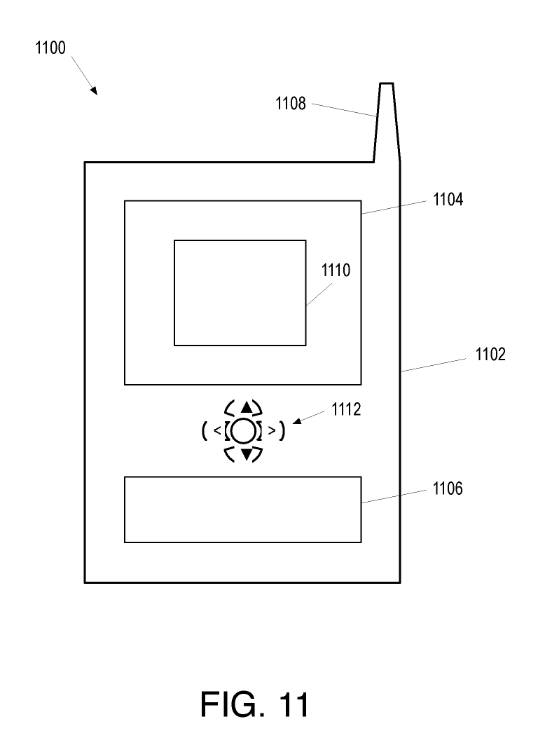

As shown in FIG. 11, device 1100 may include a housing 1102, a display 1104, an input/output (I/O) device 1106, and an antenna 1108. Device 1100 also may include navigation features 1112. Display 1104 may include any suitable display unit for displaying information appropriate for a mobile computing device. I/O device 1106 may include any suitable I/O device for entering information into a mobile computing device. Examples for I/O device 1106 may include an alphanumeric keyboard, a numeric keypad, a touch pad, input keys, buttons, switches, rocker switches, microphones, speakers, voice recognition device and software, and so forth. Information also may be entered into device 1100 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first embodiments, a computer-implemented method for automatic speaker verification comprises receiving an utterance, extracting features associated with at least a portion of the received utterance, and classifying the utterance in a replay utterance class or an original utterance class based on at least one of a statistical classification or a margin classification of the utterance based on the extracted features.

Further to the first embodiments, the extracted features comprise Mel frequency cepstrum coefficients representing a power spectrum of the received utterance.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, and/or wherein the replay mixture model and the original mixture model comprise Gaussian mixture models.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, wherein the replay mixture model and the original mixture model comprise Gaussian mixture models.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, wherein the replay mixture model and the original mixture model comprise pre-trained mixture models trained based on a set of recordings comprising original recordings recorded via a first device and replay recordings comprising replays of the original recordings replayed via a second device and recorded via the first device.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, wherein the replay mixture model and the original mixture model comprise pre-trained mixture models trained based on a set of recordings comprising original recordings recorded via a first device and replay recordings comprising replays of the original recordings replayed via a second device and recorded via the first device, wherein training the replay mixture model comprises extracting a plurality of replay recording features based on the replay recordings and adapting a universal background model to the plurality of replay recording features based on a maximum a posteriori adaption of the universal background model to generate the replay mixture model.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, wherein the replay mixture model and the original mixture model comprise pre-trained mixture models trained based on a set of recordings comprising original recordings recorded via a first device and replay recordings comprising replays of the original recordings replayed via a second device and recorded via the first device, wherein training the replay mixture model comprises extracting a plurality of replay recording features based on the replay recordings and adapting a universal background model to the plurality of replay recording features based on a maximum a posteriori adaption of the universal background model to generate the replay mixture model.

Further to the first embodiments, classifying the utterance is based on the statistical classification, and wherein classifying the utterance comprises determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, wherein the log-likelihood the utterance was produced by the replay mixture model comprises a sum of frame-wise log-likelihoods determined based on temporal frames of the utterance.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein extracting the utterance super vector comprises concatenating mean vectors of the utterance mixture model.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein the utterance mixture model comprises a Gaussian mixture model.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein extracting the utterance super vector comprises concatenating mean vectors of the utterance mixture model and/or wherein the utterance mixture model comprises a Gaussian mixture model.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein the support vector machine comprises a pre-trained support vector machine trained based on a set of recordings comprising original recordings recorded via a first device and replay recordings comprising replays of the original recordings replayed via a second device and recorded via the first device.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein the support vector machine comprises a pre-trained support vector machine trained based on a set of recordings comprising original recordings recorded via a first device and replay recordings comprising replays of the original recordings replayed via a second device and recorded via the first device, wherein training the support vector machine comprises extracting a plurality of sets of replay recording features based on the replay recordings and a plurality of sets original recording features based on the original recordings, adapting a universal background model to each of the plurality of sets of replay recording features and to each of the plurality of sets of original recording features based on a maximum a posteriori adaption of the universal background model to generate a plurality of original mixture models and a plurality of replay mixture models, extracting an original recording super vector from each of the plurality of original mixture models and a replay recording super vector from each of the plurality of replay mixture models, and training the super vector machine based on the plurality of original recording super vectors and the plurality of replay recording super vectors.

Further to the first embodiments, classifying the utterance is based on the margin classification, and wherein classifying the utterance comprises performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein the support vector machine comprises a pre-trained support vector machine trained based on a set of recordings comprising original recordings recorded via a first device and replay recordings comprising replays of the original recordings replayed via a second device and recorded via the first device, wherein training the support vector machine comprises extracting a plurality of sets of replay recording features based on the replay recordings and a plurality of sets original recording features based on the original recordings, adapting a universal background model to each of the plurality of sets of replay recording features and to each of the plurality of sets of original recording features based on a maximum a posteriori adaption of the universal background model to generate a plurality of original mixture models and a plurality of replay mixture models, extracting an original recording super vector from each of the plurality of original mixture models and a replay recording super vector from each of the plurality of replay mixture models, and training the super vector machine based on the plurality of original recording super vectors and the plurality of replay recording super vectors.

Further to the first embodiments, the method further comprises denying access to a system when the utterance is classified in the replay utterance class.

In one or more second embodiments, a system for providing automatic speaker verification comprises a speaker for receiving an utterance, a memory configured to store automatic speaker verification data, and a central processing unit coupled to the memory, wherein the central processing unit comprises feature extraction circuitry configured to extract features associated with at least a portion of the received utterance and classifier circuitry configured to classify the utterance in a replay utterance class or an original utterance class based on at least one of a statistical classification or a margin classification of the utterance based on the extracted features.

Further to the second embodiments, the features comprise Mel frequency cepstrum coefficients representing a power spectrum of the received utterance.

Further to the second embodiments, the classifier circuitry is configured to classify the utterance based on the statistical classification, the classifier circuitry comprising scoring circuitry configured to determine a score for the utterance as a ratio of a log-likelihood the utterance was produced by a replay mixture model to a log-likelihood the utterance was produced by an original mixture model and score comparison circuitry configured to determine whether the utterance is in the replay utterance class or the original utterance class based on a score comparison of the score and a predetermined threshold.

Further to the second embodiments, the classifier circuitry is configured to classify the utterance based on the statistical classification, the classifier circuitry comprising scoring circuitry configured to determine a score for the utterance as a ratio of a log-likelihood the utterance was produced by a replay mixture model to a log-likelihood the utterance was produced by an original mixture model and score comparison circuitry configured to determine whether the utterance is in the replay utterance class or the original utterance class based on a score comparison of the score and a predetermined threshold, wherein the replay mixture model and the original mixture model comprise Gaussian mixture models.

Further to the second embodiments, the classifier circuitry is configured to classify the utterance based on the marginal classification, the classifier circuitry comprising maximum-a-posteriori adaptation circuitry configured to perform a maximum-a-posteriori adaptation of a universal background model based on the extracted features to generate an utterance mixture model, super vector extraction circuitry configured to extract an utterance super vector based on the utterance mixture model, and a support vector machine configured to classify the utterance in the replay utterance class or the original utterance class based on the super vector.

Further to the second embodiments, the classifier circuitry is configured to classify the utterance based on the marginal classification, the classifier circuitry comprising maximum-a-posteriori adaptation circuitry configured to perform a maximum-a-posteriori adaptation of a universal background model based on the extracted features to generate an utterance mixture model, super vector extraction circuitry configured to extract an utterance super vector based on the utterance mixture model, and a support vector machine configured to classify the utterance in the replay utterance class or the original utterance class based on the super vector, wherein the super vector extraction circuitry being configured to extract the utterance super vector comprises the super vector extraction circuitry configured to concatenate mean vectors of the utterance mixture model.

Further to the second embodiments, the classifier circuitry is configured to classify the utterance based on the marginal classification, the classifier circuitry comprising maximum-a-posteriori adaptation circuitry configured to perform a maximum-a-posteriori adaptation of a universal background model based on the extracted features to generate an utterance mixture model, super vector extraction circuitry configured to extract an utterance super vector based on the utterance mixture model, and a support vector machine configured to classify the utterance in the replay utterance class or the original utterance class based on the super vector, wherein the utterance mixture model comprises a Gaussian mixture model.

Further to the second embodiments, the system further comprises access denial circuitry configured to deny access to the system when the utterance is classified in the replay utterance class.

In one or more third embodiments, a system for providing automatic speaker verification comprises means for receiving an utterance, means for extracting features associated with at least a portion of the received utterance, and means for classifying the utterance in a replay utterance class or an original utterance class based on at least one of a statistical classification or a margin classification of the utterance based on the extracted features.

Further to the third embodiments, the means for classifying the utterance classify the utterance based on the statistical classification, the system further comprising means for determining a score for the utterance as a ratio of a log-likelihood the utterance was produced by a replay mixture model to a log-likelihood the utterance was produced by an original mixture model and means for determining whether the utterance is in the replay utterance class or the original utterance class based on a score comparison of the score and a predetermined threshold.

Further to the third embodiments, the means for classifying the utterance classify the utterance based on the marginal classification, the system further comprising means for performing a maximum-a-posteriori adaptation of a universal background model based on the extracted features to generate an utterance mixture model, means for extracting an utterance super vector based on the utterance mixture model, and means for classifying, via a support vector machine, the utterance in the replay utterance class or the original utterance class based on the utterance super vector.

In one or more fourth embodiments, at least one machine readable medium comprises a plurality of instructions that in response to being executed on a computing device, cause the computing device to provide automatic speaker verification by receiving an utterance, extracting features associated with at least a portion of the received utterance, and classifying the utterance in a replay utterance class or an original utterance class based on at least one of a statistical classification or a margin classification of the utterance based on the extracted features.

Further to the fourth embodiments, the features comprise Mel frequency cepstrum coefficients representing a power spectrum of the received utterance.

Further to the fourth embodiments, classifying the utterance is based on the statistical classification, the machine readable medium further comprising instructions that cause the computing device to classify the utterance by determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold.

Further to the fourth embodiments, classifying the utterance is based on the statistical classification, the machine readable medium further comprising instructions that cause the computing device to classify the utterance by determining a score for the utterance as a ratio of a log-likelihood the utterance was produced by a replay mixture model to a log-likelihood the utterance was produced by an original mixture model and determining whether the utterance is in the replay utterance class or the original utterance class based on a score comparison of the score and a predetermined threshold, wherein the replay mixture model and the original mixture model comprise Gaussian mixture models.

Further to the fourth embodiments, classifying the utterance is based on the marginal classification, the machine readable medium further comprising instructions that cause the computing device to classify the utterance by performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector.

Further to the fourth embodiments, classifying the utterance is based on the marginal classification, the machine readable medium further comprising instructions that cause the computing device to classify the utterance by performing a maximum-a-posteriori adaptation of a universal background model based on the extracted features to generate an utterance mixture model, extracting an utterance super vector based on the utterance mixture model, and classifying, via a support vector machine, the utterance in the replay utterance class or the original utterance class based on the utterance super vector, wherein extracting the utterance super vector comprises concatenating mean vectors of the utterance mixture model.

In on or more fifth embodiments, at least one machine readable medium may include a plurality of instructions that in response to being executed on a computing device, causes the computing device to perform a method according to any one of the above embodiments.

In on or more sixth embodiments, an apparatus may include means for performing a method according to any one of the above embodiments.

It will be recognized that the embodiments are not limited to the embodiments so described, but can be practiced with modification and alteration without departing from the scope of the appended claims. For example, the above embodiments may include specific combination of features. However, the above embodiments are not limited in this regard and, in various implementations, the above embodiments may include the undertaking only a subset of such features, undertaking a different order of such features, undertaking a different combination of such features, and/or undertaking additional features than those features explicitly listed. The scope of the embodiments should, therefore, be determined with reference to the appended claims, along with the full scope of equivalents to which such claims are entitled.

1-25. (canceled)

26. A computer-implemented method for automatic speaker verification comprising:
receiving an utterance;
extracting features associated with at least a portion of the received utterance; and
classifying the utterance in a replay utterance class or an original utterance class based on at least one of a statistical classification or a margin classification of the utterance based on the extracted features.

27. The method of claim 26, wherein the extracted features comprise Mel frequency cepstrum coefficients representing a power spectrum of the received utterance.

28. The method of claim 26, wherein classifying the utterance is based on the statistical classification, and wherein classifying the utterance comprises:
determining a score for the utterance as a ratio of a log-likelihood the utterance was produced by a replay mixture model to a log-likelihood the utterance was produced by an original mixture model; and
determining whether the utterance is in the replay utterance class or the original utterance class based on a score comparison of the score and a predetermined threshold.

29. The method of claim 28, wherein the replay mixture model and the original mixture model comprise Gaussian mixture models.

30. The method of claim 28, wherein the replay mixture model and the original mixture model comprise pre-trained mixture models trained based on a set of recordings comprising original recordings recorded via a first device and replay recordings comprising replays of the original recordings replayed via a second device and recorded via the first device.

31. The method of claim 30, wherein training the replay mixture model comprises:
extracting a plurality of replay recording features based on the replay recordings; and
adapting a universal background model to the plurality of replay recording features based on a maximum a posteriori adaption of the universal background model to generate the replay mixture model.

32. The method of claim 28, wherein the log-likelihood the utterance was produced by the replay mixture model comprises a sum of frame-wise log-likelihoods determined based on temporal frames of the utterance.

33. The method of claim 26, wherein classifying the utterance is based on the margin classification, and wherein classifying the utterance comprises:
performing a maximum-a-posteriori adaptation of a universal background model based on the extracted features to generate an utterance mixture model;
extracting an utterance super vector based on the utterance mixture model; and
classifying, via a support vector machine, the utterance in the replay utterance class or the original utterance class based on the utterance super vector.

34. The method of claim 33, wherein extracting the utterance super vector comprises concatenating mean vectors of the utterance mixture model.

35. The method of claim 33, wherein the utterance mixture model comprises a Gaussian mixture model.

36. The method of claim 33, wherein the support vector machine comprises a pre-trained support vector machine trained based on a set of recordings comprising original recordings recorded via a first device and replay recordings comprising replays of the original recordings replayed via a second device and recorded via the first device.

37. The method of claim 36, wherein training the support vector machine comprises:
extracting a plurality of sets of replay recording features based on the replay recordings and a plurality of sets original recording features based on the original recordings;
adapting a universal background model to each of the plurality of sets of replay recording features and to each of the plurality of sets of original recording features based on a maximum a posteriori adaption of the universal background model to generate a plurality of original mixture models and a plurality of replay mixture models;
extracting an original recording super vector from each of the plurality of original mixture models and a replay recording super vector from each of the plurality of replay mixture models; and
training the super vector machine based on the plurality of original recording super vectors and the plurality of replay recording super vectors.

38. The method of claim 26, further comprising:
denying access to a system when the utterance is classified in the replay utterance class.

39. A system for providing automatic speaker verification comprising:
a speaker for receiving an utterance;
a memory configured to store automatic speaker verification data; and
a central processing unit coupled to the memory, wherein the central processing unit comprises:
feature extraction circuitry configured to extract features associated with at least a portion of the received utterance; and
classifier circuitry configured to classify the utterance in a replay utterance class or an original utterance class based on at least one of a statistical classification or a margin classification of the utterance based on the extracted features.

40. The system of claim 39, wherein the features comprise Mel frequency cepstrum coefficients representing a power spectrum of the received utterance.

41. The system of claim 39, wherein the classifier circuitry is configured to classify the utterance based on the statistical classification, the classifier circuitry comprising:
scoring circuitry configured to determine a score for the utterance as a ratio of a log-likelihood the utterance was produced by a replay mixture model to a log-likelihood the utterance was produced by an original mixture model; and
score comparison circuitry configured to determine whether the utterance is in the replay utterance class or the original utterance class based on a score comparison of the score and a predetermined threshold.

42. The system of claim 41, wherein the replay mixture model and the original mixture model comprise Gaussian mixture models.

43. The system of claim 39, wherein the classifier circuitry is configured to classify the utterance based on the marginal classification, the classifier circuitry comprising:
maximum-a-posteriori adaptation circuitry configured to perform a maximum-a-posteriori adaptation of a universal background model based on the extracted features to generate an utterance mixture model;
super vector extraction circuitry configured to extract an utterance super vector based on the utterance mixture model; and
a support vector machine configured to classify the utterance in the replay utterance class or the original utterance class based on the super vector.

44. The system of claim 43, wherein the super vector extraction circuitry being configured to extract the utterance super vector comprises the super vector extraction circuitry configured to concatenate mean vectors of the utterance mixture model.

45. At least one machine readable medium comprising a plurality of instructions that in response to being executed on a computing device, cause the computing device to provide automatic speaker verification by:
receiving an utterance;
extracting features associated with at least a portion of the received utterance; and
classifying the utterance in a replay utterance class or an original utterance class based on at least one of a statistical classification or a margin classification of the utterance based on the extracted features.

46. The machine readable medium of claim 45, wherein the features comprise Mel frequency cepstrum coefficients representing a power spectrum of the received utterance.

47. The machine readable medium of claim 45, wherein classifying the utterance is based on the statistical classification, the machine readable medium further comprising instructions that cause the computing device to classify the utterance by:
determining a score for the utterance as a ratio of a log-likelihood the utterance was produced by a replay mixture model to a log-likelihood the utterance was produced by an original mixture model; and
determining whether the utterance is in the replay utterance class or the original utterance class based on a score comparison of the score and a predetermined threshold.

48. The machine readable medium of claim 47, wherein the replay mixture model and the original mixture model comprise Gaussian mixture models.

49. The machine readable medium of claim 45, wherein classifying the utterance is based on the marginal classification, the machine readable medium further comprising instructions that cause the computing device to classify the utterance by:
performing a maximum-a-posteriori adaptation of a universal background model based on the extracted features to generate an utterance mixture model;
extracting an utterance super vector based on the utterance mixture model; and
classifying, via a support vector machine, the utterance in the replay utterance class or the original utterance class based on the utterance super vector.

50. The machine readable medium of claim 49, wherein extracting the utterance super vector comprises concatenating mean vectors of the utterance mixture model.
